(19) United States
(12) Patent Application Publication
(10) Pub. No.: US 2021/0072492 A1
(43) Pub. Date: Mar. 11, 2021

(54) LENS DRIVING DEVICE, CAMERA DEVICE, AND ELECTRONIC APPARATUS

(71) Applicant: New Shicoh Motor Co., Ltd., Zhejiang (CN)

(72) Inventor: Kokichi Terajima, Kanagawa (JP)

(21) Appl. No.: 17/005,480

(22) Filed: Aug. 28, 2020

(30) Foreign Application Priority Data
Sep. 11, 2019 (JP) 2019-165079

(51) Int. Cl. G02B 7/04; G02B 27/64; G03B 3/00; G03B 13/32

(52) U.S. Cl. CPC G02B 7/04; G02B 27/646; G03B 2205/0015; G03B 13/32; G03B 2205/0023; G03B 3/00

(57) ABSTRACT

Provided are a lens driving device, a camera device, and an electronic apparatus, with which a lens can be moved on both sides with respect to one axial direction. A lens driving device (10) includes: a stator (12); a mover (14), which is supported to be freely movable with respect to the stator (12), and includes a lens holder (22) configured to hold a lens; and a first driving member (28) and a second driving member (30), which are provided apart from each other in a moving direction of the mover (14), and extend in a direction intersecting with the moving direction of the mover (14), the first driving member (28) and the second driving member (30) each including a shape memory alloy portion (28, 30). In the first driving member (28) and the second driving member (30), one end of the first driving member (28) and one end of the second driving member (30) are connected to the stator (12), and another end of the first driving member (28) and another end of the second driving member (30) are connected to the mover (14).

### BACKGROUND OF THE INVENTION

### 1. Field of the Invention

The present invention relates to a lens driving device, a camera device, and an electronic apparatus.

### 2. Description of the Related Art

As a lens driving device, there has been known one using a shape memory alloy. For example, in US Patent Application Publication No. 2031/0217031, there is disclosed a lens driving device including a shape memory alloy member and a conductive member each extending in a direction orthogonal to an optical axis. The shape memory alloy member and the conductive member are arranged side by side in an optical axis direction. When the shape memory alloy member is energized via the conductive member, a lens support member is moved from a reference position toward one side of the optical axis direction.

### SUMMARY OF THE INVENTION

The present invention has an object to provide a lens driving device, a camera device, and an electronic apparatus, with which a lens can be moved on both sides with respect to one axial direction.

According to at least one aspect of the present invention, there is provided a lens driving device including: a stator; a mover, which is supported to be freely movable with respect to the stator, and includes a lens holder configured to hold a lens; and a first driving member and a second driving member, which are provided apart from each other in a moving direction of the mover, and extend in a direction intersecting with the moving direction of the mover, the first driving member and the second driving member each including a shape memory alloy portion, wherein, in the first driving member and the second driving member, one end of the first driving member and one end of the second driving member are connected to the stator, and another end of the first driving member and another end of the second driving member are connected to the mover.

An intermediate support member may be provided between the first driving member and the second driving member. It is preferred that the intermediate support member be made of a conductive material for energizing the first driving member or the second driving member.

Further, it is preferred that the mover be supported by an elastic member so that the mover is freely tiltable.

Further, a guide portion may be provided between the stator and the mover. The guide portion includes, for example, a spherical member, and the stator and the mover face each other through intermediation of the spherical member. In order to regulate and guide the movement of the spherical member, a regulating member and a guide groove are provided.

Further, the first driving member and the second driving member may each include a first part and a second part formed to reciprocate between the stator and the mover. Further, a width between the first driving member and the second driving member may be gradually narrowed toward the mover.

Further, each of the first driving member and the second driving member may include a first shape memory alloy portion on the stator side, a second shape memory alloy portion on the mover side, and an intermediate connection terminal portion configured to connect between the first shape memory alloy portion and the second shape memory alloy portion, and in the first driving member and the second driving member, positions of the first shape memory alloy portion and the second shape memory alloy portion may be switched in the moving direction of the mover with respect to the intermediate connection terminal portion serving as a boundary.

In addition, a plurality of first driving members and a plurality of second driving members may form sets that are arranged in rotational symmetry around the mover. In this case, in addition to the first driving member and the second driving member, a third driving member and further a fourth driving member may be provided to form a circulation arrangement. At this time, the third driving member and the fourth driving member may be provided to be arranged side by side in a direction orthogonal to the moving direction of the mover. Further, the first driving member, the second driving member, and the third driving member may be integrally formed, or the first driving member, the second driving member, the third driving member, and the fourth driving member may be integrally formed.

Further, according to another aspect of the present invention, there is provided a camera device including the above-mentioned lens driving device.

In addition, according to still another aspect of the present invention, there is provided an electronic apparatus including the above-mentioned camera device.

According to at least one embodiment of the present invention, the first driving member and the second driving member each including the shape memory alloy portion are provided in the direction intersecting with the moving direction of the mover. Thus, when the first driving member and the second driving member are selectively energized, the lens can be moved on both sides with respect to one axial direction.

### BRIEF DESCRIPTION OF THE DRAWINGS

FIG. 1 is a perspective view for illustrating a lens driving device according to a first embodiment of the present invention.

FIG. 2 is a side view for illustrating the lens driving device according to the first embodiment of the present invention.

FIG. 3 is an exploded perspective view for illustrating the lens driving device according to the first embodiment of the present invention as viewed from one direction.

FIG. 4 is an exploded perspective view for illustrating the lens driving device according to the first embodiment of the present invention as viewed from another direction.

FIG. 5 is a cross-sectional view for illustrating main parts of a guide portion in the lens driving device according to the first embodiment of the present invention.

FIG. 6A and FIG. 6B are side views for illustrating an elastic member and its surroundings in the lens driving device according to the first embodiment of the present invention.

FIG. 7A, FIG. 7B, and FIG. 7C are side views for illustrating an action of the lens driving device according to the first embodiment of the present invention.

FIG. 8 is a perspective view for illustrating a lens driving device according to a second embodiment of the present invention.

FIG. 9 is a side view for illustrating the lens driving device according to the second embodiment of the present invention.

FIG. 10 is a perspective view for illustrating a lens driving device according to a third embodiment of the present invention.

FIG. 11 is a side view for illustrating an action of the lens driving device according to the third embodiment of the present invention.

FIG. 12 is a perspective view for illustrating a lens driving device according to a fourth embodiment of the present invention.

FIG. 13 is an exploded perspective view for illustrating a first driving member, a second driving member, a third driving member, a fourth driving member, and their surroundings in the lens driving device according to the fourth embodiment of the present invention.

FIG. 14 is a perspective view for illustrating main parts in a fifth embodiment of the present invention.

FIG. 15 is a perspective view for illustrating main parts in a sixth embodiment of the present invention.

### DESCRIPTION OF THE EMBODIMENTS

Embodiments of the present invention are now described with reference to the accompanying drawings.

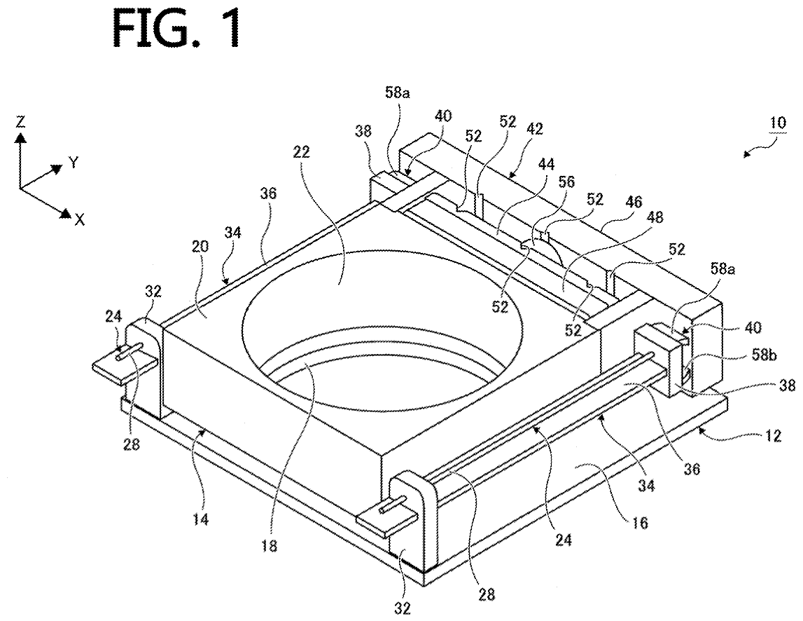

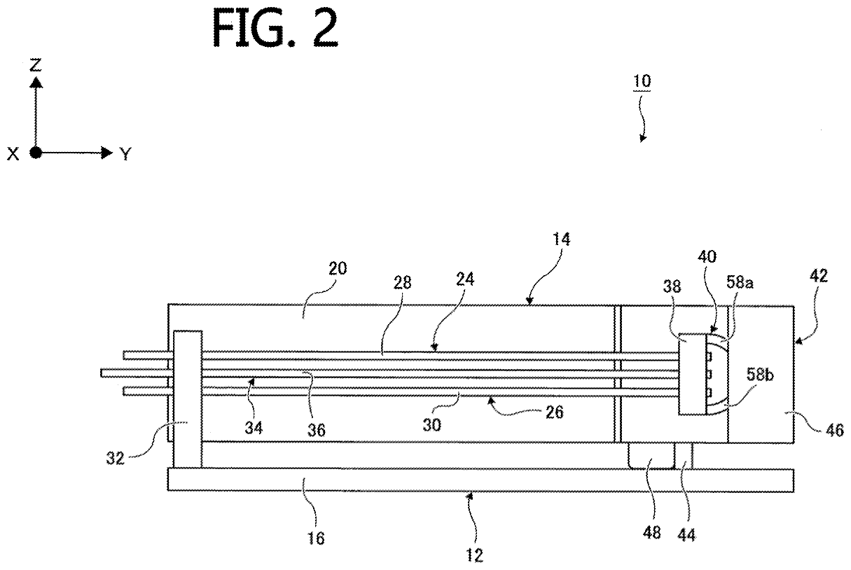

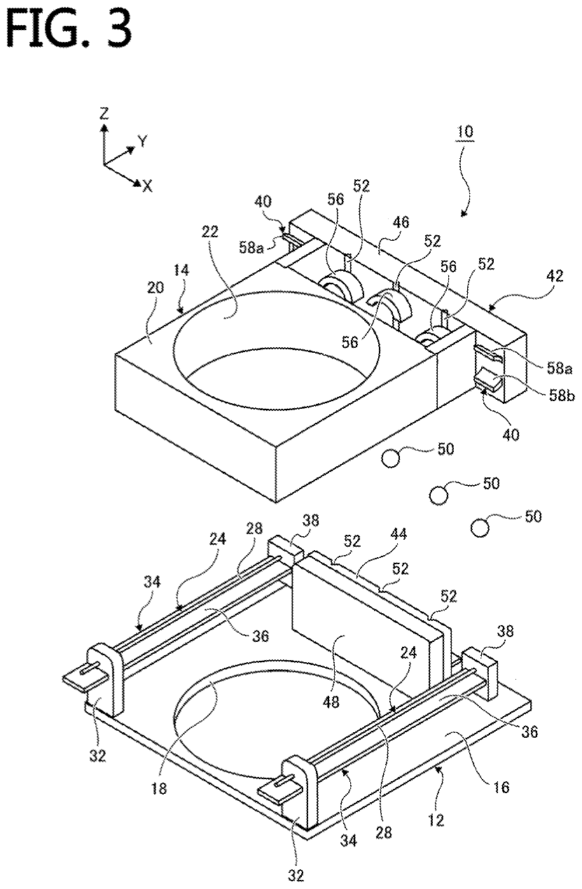

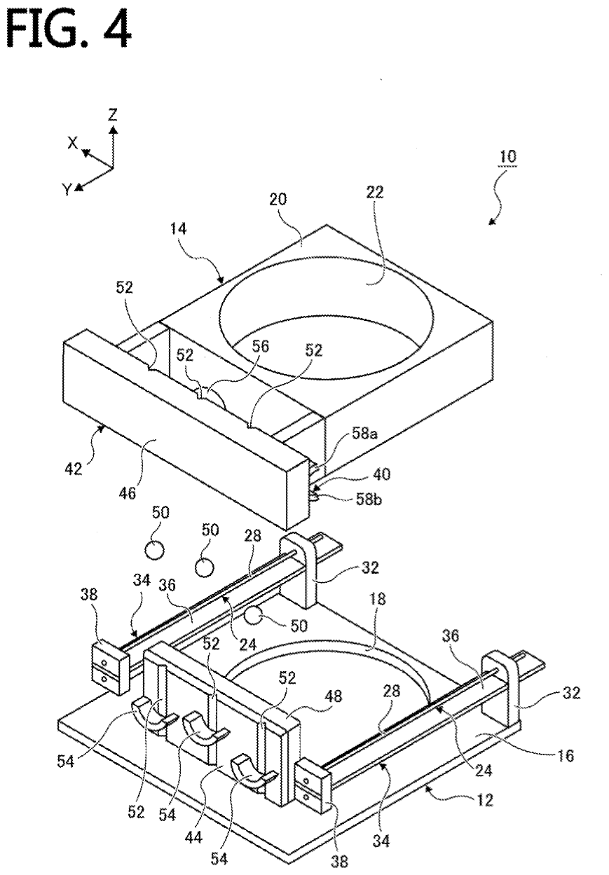

FIG. 1 to FIG. 7C are illustrations of a first embodiment of the present invention. A lens driving device 10 according to the first embodiment of the present invention includes a stator 12, and a mover 14 supported to be freely movable with respect to the stator 12.

The stator 12 includes a stator main body portion 16 formed into a quadrilateral plate shape, and a light passing hole 18 having a circular shape is formed at the center of the stator main body portion 16. The mover 14 includes a mover main body portion 20 formed into a quadrilateral shape that is slightly smaller than the stator main body portion 16, and a lens holder 22 configured to hold a lens is provided at the center of the mover main body portion 20. The lens holder 22 is formed as a circular hole, and a lens member is held in the lens holder 22 so that an optical axis of the lens member is parallel to a Z direction.

In an XYZ rectangular coordinate system, an optical axis direction of the lens member held by the lens holder 22, that is, a direction in which light enters the lens member corresponds to the Z direction, and directions orthogonal to the Z direction correspond to XY directions. The mover 14 is moved in the Z direction with respect to the stator 12.

First driving members 24 are each formed of a wire-shaped shape memory alloy portion 28, and second driving members 26 are each formed of a wire-shaped shape memory alloy portion 30. The shape memory alloy portions 28 and 30 are made of shape memory alloys such as nickel-titanium, cooper-zinc-aluminum, or other alloys. The shape memory alloy portions 28 and 30 are returned to their original shapes when the shape memory alloy portions 28 and 30 reach a certain temperature or higher. In this case, the original shapes are shorter than the shapes illustrated in the figures, and when the shape memory alloy portions 28 and 30 reach a certain temperature or higher, the shape memory alloy portions 28 and 30 are deformed to be contracted.

The first driving member 24 and the second driving member 26 are arranged side by side with a distance in the Z direction, and extend, for example, in the Y direction. The first driving member 24 and the second driving member 26 are arranged on an outer side of each of both side surfaces of the mover main body portion 20 in, for example, the X direction.

Further, in the first driving member 24 and the second driving member 26, one end of the first driving member 24 and one end of the second driving member 26 are connected to the stator 12, and another end of the first driving member 24 and another end of the second driving member 26 are connected to the mover 14.

In the first embodiment, fixing columns 32 are formed to protrude in the Z direction in the vicinity of corner portions of a −Y-side end surface of the stator main body portion 16. The one end of the first driving member 24 and the one end of the second driving member 26 are fixed to corresponding one of the fixing columns 32.

Further, the another end of the first driving member 24 and the another end of the second driving member 26 are fixed to corresponding one of connecting portions 38 of intermediate support members 34 to be described later, to thereby be connected to the mover 14 through intermediation of the intermediate support member 34 and an elastic member 40 to be described later.

The intermediate support members 34 are each formed of a conductor. Further, the intermediate support members 34 each include an intermediate support member main body portion 36 and the connecting portion 38. The intermediate support member main body portion 36 is arranged between the first driving member 24 and the second driving member 26 in the Z direction. The connecting portion 38 is provided at a counter-fixing column end of the intermediate support member main body portion 36. The intermediate support member main body portion 36 is formed into a plate shape, and has elasticity to be curvable in the Z direction. Further, one end of the intermediate support member main body portion 36 is fixed to the fixing column 32, and protrudes from the fixing column 32. This protruding part is connected to, for example, the earth. The connecting portion 38 forms a T shape together with the intermediate support member main body portion 36. The another end of the first driving member 24 and the another end of the second driving member 26 are fixed to the connecting portion 38. When a voltage is applied from the fixing column 32 side to any one of the first driving member 24 and the second driving member 26, a current flows through corresponding one of the first driving member 24 and the second driving member 26 via the intermediate support member 34, and the corresponding one of the first driving member 24 and the second driving member 26 is heated by the Joule heat generated by this flowing current. When the corresponding one of the first driving member 24 and the second driving member 26 reaches a certain temperature or higher, its length is decreased.

Further, on the +Y side of the lens driving device 10, a guide portion 42 is provided. The guide portion 42 includes a stator-side guide wall portion 44 and a mover-side guide wall portion 46. The stator-side guide wall portion 44 is provided to erect from the stator main body portion 16 in the Z direction. Further, a magnet 48 is fixed to the −Y side of the stator-side guide wall portion 44. The mover-side guide wall portion 46 surrounds, in a non-contact manner, a +Y-side back surface part and ±X-side both side surface parts of each of the stator-side guide wall portion 44 and the magnet 48.

Further, for example, three spherical members 50 each made of a magnetic material are arranged between the stator-side guide wall portion 44 and the mover-side guide wall portion 46. Further, the stator-side guide wall portion 44 and the mover-side guide wall portion 46 each have V-shaped guide grooves 52 extending in the Z direction. The spherical members 50 are fitted to the guide grooves 52 so that the spherical members 50 are guided in the Z direction while the spherical members 50 are prevented from deviating in the X direction. The center spherical member 50 is arranged at a position different in the Z direction from positions of the spherical members 50 on both sides so that the three spherical members 50 form one plane.

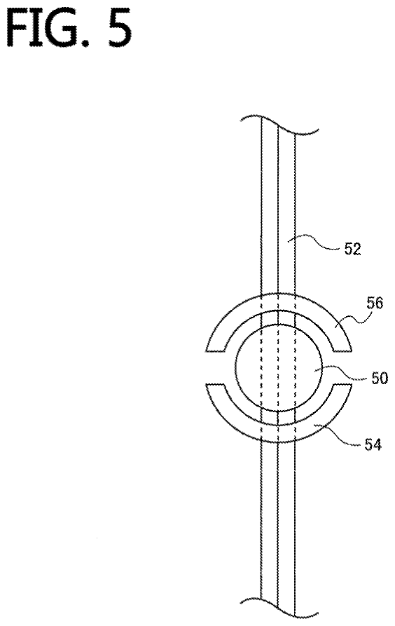

As illustrated in FIG. 5 as well, the stator-side guide wall portion 44 has three stator-side regulating portions 54 provided thereon, which are each made of a magnetic material. The stator-side regulating portions 54 are each formed to protrude toward the mover-side guide wall portion 46 side so that an upper part thereof is concave in a semi-circular shape. Further, the mover-side guide wall portion 46 has three mover-side regulating portions 56 provided thereon, which are each made of a magnetic material. The mover-side regulating portions 56 are each formed to protrude toward the stator-side guide wall portion 44 side so that a lower part thereof is concave in a semi-circular shape. The spherical members 50 are each arranged to be separated apart from the stator-side regulating portion 54 and the mover-side regulating portion 56 in the Z direction. The three stator-side regulating portions 54 and the three mover-side regulating portions 56 are opposed to each other, respectively, in the Z direction.

In this case, a set of the stator-side regulating portion 54 and the mover-side regulating portion 56 arranged at the center in accordance with the position of the spherical member 50 is arranged to be shifted in the +Z direction from sets of the stator-side regulating portions 54 and the mover-side regulating portions 56 arranged on both sides. The mover-side regulating portions 56 are attracted to the magnet 48 so that the mover-side guide wall portion 46 can keep a posture along the stator-side guide wall portion 44 through intermediation of the spherical members 50. That is, the mover 14 can keep a stable posture.

Further, the spherical members 50, the stator-side regulating portions 54, and the mover-side regulating portions 56 are each made of a magnetic material, and those spherical members 50, stator-side regulating portions 54, and mover-side regulating portions 56 are opposed to the magnet 48 across the stator-side guide wall portion 44. Thus, in the spherical members 50, the stator-side regulating portions 54, and the mover-side regulating portions 56, sides close to the magnet 48 are all magnetized to the same magnetic pole. Therefore, the spherical members 50, the stator-side regulating portions 54, and the mover-side regulating portions 56 are opposed to have the same pole in the Z direction. Therefore, the spherical members 50 and the mover-side regulating portions 56 repel the stator-side regulating portions 54 by magnetic forces, and the spherical members 50 and the mover-side regulating portions 56 also repel each other. Therefore, it is possible to avoid generation of a friction at the time of movement of the mover 14, which is caused when the positions of the spherical members 50 are deviated due to gravity or other external force or motion of the mover 14 and thus the spherical members 50 hit the stator-side regulating portions 54 and the mover-side regulating portions 56.

The set of the stator-side regulating portion 54 and the mover-side regulating portion 56 arranged at the center may be arranged so that the stator-side regulating portion 54 is located on the upper side and the mover-side regulating portion 56 is located on the lower side. The stator-side regulating portions 54 are provided on both sides of the Z direction, and hence a repulsive force strongly acts even when the spherical member 50 moves on any side of the Z direction. Therefore, there can be obtained a force to return the spherical member 50 and the mover-side regulating portion 56 to positions at which this repulsive force is balanced when the applied driving force is returned to 0. Further, the stator-side regulating portions 54 may be eliminated or formed as a mechanical stopper configured to mechanically stop the movement of the mover 14 in the Z direction, and the mover-side regulating portions 56 may each be formed into an annular shape so that the spherical member 50 is arranged therein. In this case, the spherical member 50 tries to stay at the center position of the mover-side regulating portion 56, and hence the spherical member 50 is further less liable to hit the mover-side regulating portion 56.

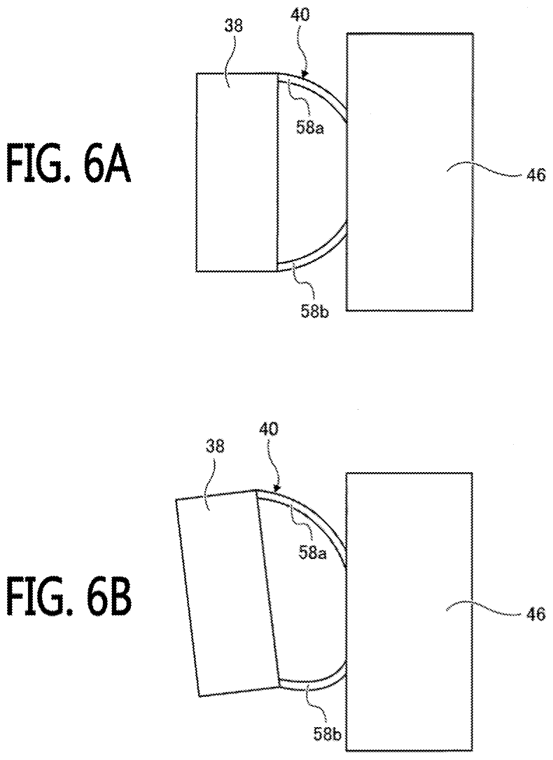

As illustrated in FIG. 6A and FIG. 6B, the elastic members 40 each include two elastic member pieces 58a and 58b provided apart from each other in, for example, the Z direction. In the two elastic member pieces 58a and 58b, one end of the elastic member piece 58a and one end of the elastic member piece 58b are fixed to the connecting portion 38, and another end of the elastic member piece 58a and another end of the elastic member piece 58b are fixed to the mover-side guide wall portion 46. The upper elastic member piece 58a is curved in the −Z direction, and the lower elastic member piece 58b is curved in the +Z direction. For example, when the first driving member 24 is energized from the state of FIG. 6A, as illustrated in FIG. 6B, the connecting portion 38 is moved in the +Z direction while being rotated in the counterclockwise direction. At this time, the upper elastic member piece 58b extends and the lower elastic member piece 58b contracts, and thus the elastic member pieces 58a and 58b allow the mover-side guide wall portion 46 to linearly move in the +Z direction while preventing the mover-side guide wall portion 46 from changing its posture in accordance with the rotation of the connecting portion 38.

Next, description is given of an action of the lens driving device 10 according to the above-mentioned first embodiment.

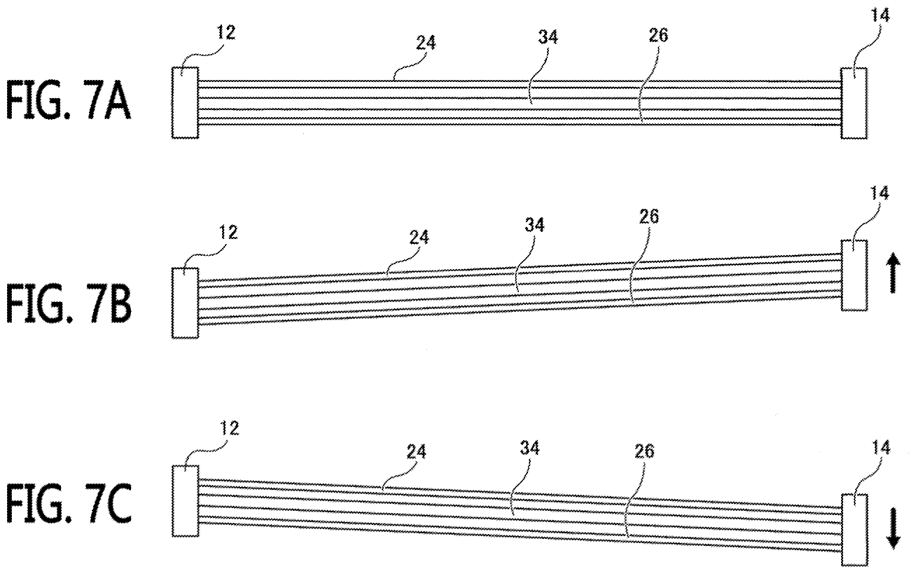

As illustrated in FIG. 7A, when the first driving member 24 and the second driving member 26 are not energized, the mover 14 is kept at the center position in the Z direction. In this case, for example, when the upper first driving member 24 is energized, as illustrated in FIG. 7B, the first driving member 24 contracts, and the mover 14 is moved in the −Z direction. In contrast, as illustrated in FIG. 7C, when the second driving member 26 is energized, the second driving member 26 contracts, and the mover 14 is moved in the −Z direction.

When the energization of the first driving member 24 or the second driving member 26 is cut off from the state in which the mover 14 is moved as illustrated in FIG. 7B or FIG. 7C, an elastic force of the unenergized first driving member 24 or second driving member 26, an elastic force of the intermediate support member 34, repulsive forces of the spherical members 50 and the mover-side regulating portions 56 caused by the magnet 48, and an elastic force of the elastic member 40 act on the mover 14 so that the mover 14 is returned to its original position illustrated in FIG. 7A.

In the above-mentioned first embodiment, the lens holder 22 is provided so that the optical axis of the lens member is directed in the Z direction, and the lens member is moved in the Z direction to adjust the focus. However, the present invention is not limited thereto. For example, the lens holder may be provided so that the optical axis of the lens member is directed in the X direction, and the lens member may be moved in the Z direction to achieve image stabilization in the Z direction.

Further, in the above-mentioned first embodiment, the guide portion 42 includes the spherical members 50 each made of a magnetic material, but the spherical members 50 may each be made of a non-magnetic material. In this case, a magnetic plate or a magnet plate may be provided on the mover-side guide wall portion 46 at a position corresponding to the magnet 48 so that the magnetic plate or the magnet plate is attracted to the magnet 48, and the stator-side regulating portions 54 and the mover-side regulating portions 56 may each be made of a non-magnetic material integrally with the stator 12 and the mover 14. Further, the spherical members 50 are provided, and the guide grooves 52 are formed of V-shaped grooves, but the spherical members 50 may be eliminated, and a slider having a convex portion may be provided in place of the V-shape grooves. This slider may slide in the Z direction.

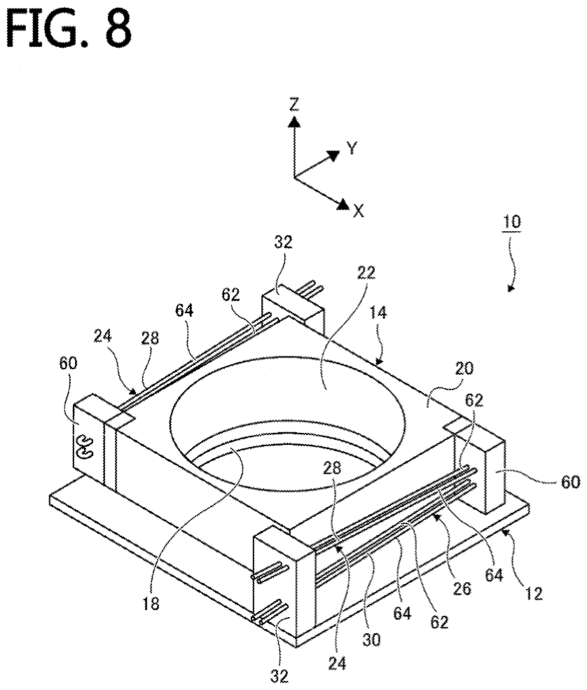

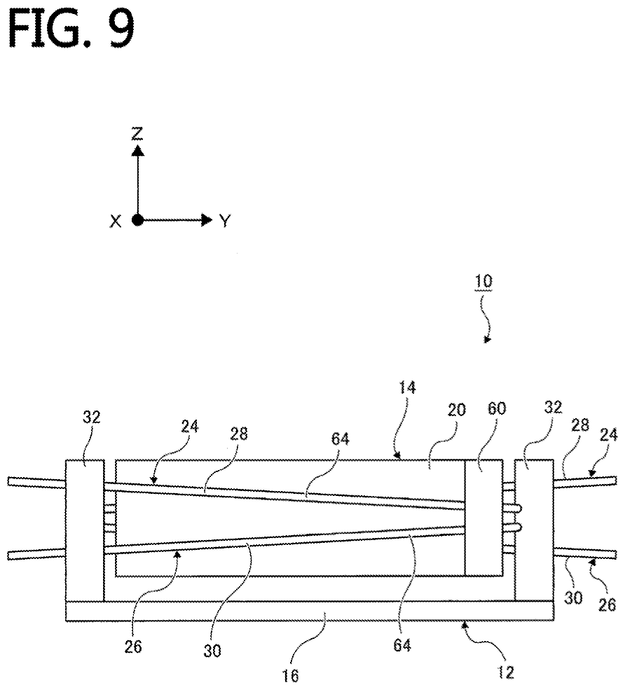

FIG. 8 and FIG. 9 are illustrations of a lens driving device 10 according to a second embodiment of the present invention.

In the second embodiment, the guide portion 42 illustrated in the first embodiment is omitted, and the mover 14 includes connecting protrusions 60 and 60 at a +X+Y end and a −X−Y end of the mover 14. The connecting protrusions 60 and 60 are formed to protrude from the mover main body portion 20 in the +X direction and the −X direction, respectively. Further, the fixing columns 32 and 32 are provided at a −X+Y end and a +X−Y end of the stator 12.

Similarly to the first embodiment, the first driving member 24 and the second driving member 26 each extend in the Y direction, and are formed of the shape memory alloy portions 28 and 30. In the second embodiment, the first driving member 24 and the second driving member 26 each include a first part 62 extending from the fixing column 32 to the connecting protrusion 60, and a second part 64 returning to the fixing column 32 from the connecting protrusion 60. The first part 62 and the second part 64 are connected to each other to make a U-turn at a part fixed to the connecting protrusion 60. Further, an interval between the first driving member 24 and the second driving member 26 in the Z direction is wider at a part fixed to the fixing column 32 than at the part fixed to the connecting protrusion. That is, in the first driving member 24, the first part 62 gradually descends from the fixing column 32 toward the connecting protrusion 60 to make a U-turn at the connecting protrusion 60, and the second part 64 gradually ascends toward the fixing column 32. In contrast, in the second driving member 26, the first part 62 gradually ascends from the fixing column 32 toward the connecting protrusion 60 to make a U-turn at the connecting protrusion 60, and the second part 64 gradually descends toward the fixing column 32. That is, the first driving member 24 and the second driving member 26 are tilted reversely.

A set of the first driving member 24 and the second driving member 26 is provided on each of both sides of the mover 14 in the X direction to form two-fold rotational symmetry (180-degree symmetry).

In the second embodiment, the first driving members 24 and the second driving members 26 each making a U-turn support the mover 14 to be freely moveable, and the intermediate support members 34 illustrated in the first embodiment are omitted.

In the second embodiment, for example, on the +X side, when the upper first driving member 24 is energized, the temperature of the first driving member 24 rises due to the Joule heat, and the first driving member 24 contracts when reaching a certain temperature or higher. The second driving member 26 does not contract, and hence the first driving member 24 and the second driving member 26 warp to the +Z side as a whole, and the mover 14 is moved in the +Z direction. At this time, the first driving member 24 contracts, and hence the mover 14 tries to tilt in the counterclockwise direction as viewed from the +X direction.

In this case, the first driving member 24 and the second driving member 26 rotate counterclockwise as viewed from the +X direction about the part fixed to the fixing column 32. On the connecting protrusion 60 side of the mover 14, the part of the first driving member 24 fixed to the connecting protrusion 60 is moved in a direction separating away from the fixing column 32 because the first driving member 24 is tilted as described above. In contrast, the second driving member 26 is tilted reversely, and thus the part of the second driving member 26 fixed to the connecting protrusion 60 is moved in a direction approaching the fixing column 32. Therefore, the connecting protrusion 60 tries to rotate in the clockwise direction as viewed from the +X direction. Thus, the first driving member 24 and the second driving member 26 can cancel the tilt of the mover 14 caused by contraction of one of the first driving member 24 and the second driving member 26 by the tilt of the mover 14 caused by reversely tilting the first driving member 24 and the second driving member 26. Therefore, the tilt of the mover 14 can be suppressed without providing the guide portion 42 in the first embodiment described above.

In the above-mentioned second embodiment, both of the first driving member 24 and the second driving member 26 are double wires with a U-turn, but it is only required that any one of the first driving member 24 and the second driving member 26 be double wires, and another thereof may not be double wires. Further, the first driving members 24 and the second driving members 26 form two-fold rotational symmetry, but the support structure can be changed to form, for example, four-fold rotational symmetry (90-degree symmetry). When the rotational symmetry structure is employed, the tilt of the mover 14 can be suppressed even without adopting the structure of reversely tilting the first driving member 24 and the second driving member 26. That is, for example, in FIG. 8, the mover 14 is moved in the +Z direction due to contraction of both of the first driving members 24, but at the same time, the mover 14 tries to tilt in the Y direction so that the connecting protrusion 60 side becomes higher and end portions on the opposite side become lower. However, those two end portions that try to tilt to be lower receive a force in the +Z direction by the connecting protrusions 60 arranged on the opposite sides in the X direction, and hence the tilt of the mover 14 is suppressed.

In the second embodiment, like parts as those in the first embodiment ace denoted by like reference symbols in the drawings, and description thereof is omitted.

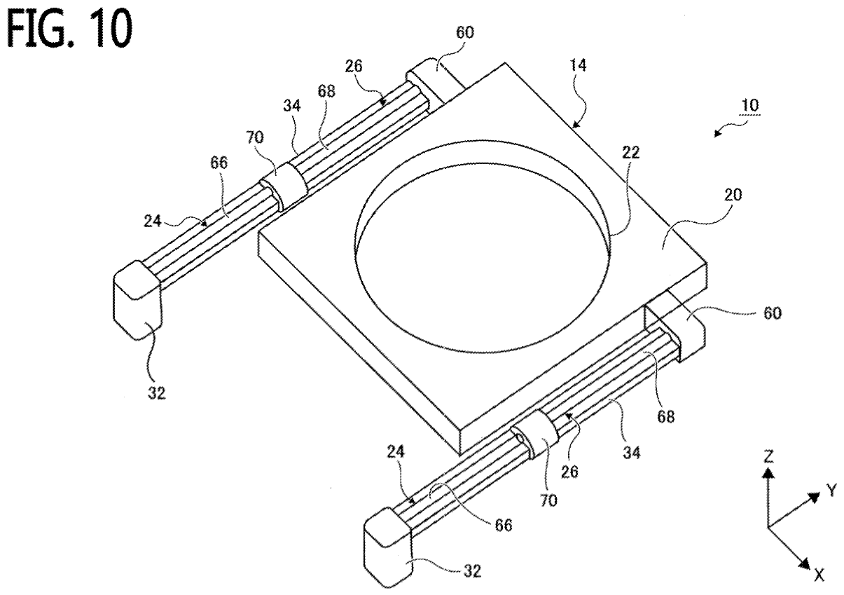

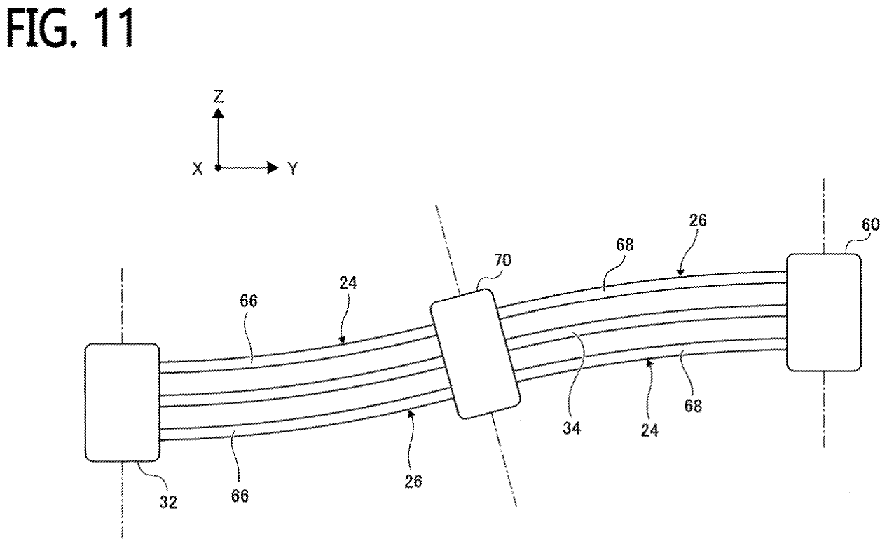

FIG. 10 and FIG. 11 are illustrations of a lens driving device 10 according to a third embodiment of the present invention.

In the third embodiment, the first driving members 24 each include a first shape memory alloy portion 66, a second shape memory alloy portion 68, and an intermediate connection terminal portion 70. The first shape memory alloy portion 66 has one end fixed to the fixing column 32. The second shape memory alloy portion 68 has one end connected to the connecting protrusion 60. Another end of the first shape memory alloy portion 66 and another end of the second shape memory alloy portion 68 are connected to the intermediate connection terminal portion 70. The first shape memory alloy portion 66 is arranged on the lower side in the Z direction, and the second shape memory alloy portion 68 is arranged on the upper side in the Z direction. The first shape memory alloy portion 66 and the second shape memory alloy portion 68 are electrically connected to each other at the intermediate connection terminal portion 70.

Similarly to the first driving members 24, the second driving members 26 each include a first shape memory alloy portion 66, a second shape memory alloy portion 68, and an intermediate connection terminal portion 70. The first shape memory alloy portion 66 has one end fixed to the fixing column 32. The second shape memory alloy portion 68 has one end connected to the connecting protrusion 60. Another end of the first shape memory alloy portion 66 and another end of the second shape memory alloy portion 68 are connected to the intermediate connection terminal portion 70. The first shape memory alloy portion 66 is arranged on the lower side in the Z direction, and the second shape memory alloy portion 68 is arranged on the upper side in the Z direction. The first shape memory alloy portion 66 and the second shape memory alloy portion 68 are electrically connected to each other at the intermediate connection terminal portion 70, but are insulated from the first driving member 24. That is, in the first driving member 24 and the second driving member 26, the positions of the first shape memory alloy portion 66 and the second shape memory alloy portion 68 are switched in the moving direction of the mover 14 with respect to the intermediate connection terminal portion 70 serving as a boundary.

Further, the intermediate support member 34 is arranged between the first driving member 24 and the second driving member 26. The second shape memory alloy portion 68 of each of the first driving member 24 and the second driving member 26 and the intermediate support member 34 are electrically connected to each other at the connecting protrusion 60, but are insulated from each other at the fixing column 32.

In the third embodiment, for example, when the first driving member 24 is energized, as illustrated in FIG. 11, the first shape memory alloy portion 66 of the first driving member 24 arranged on the upper side and the second shape memory alloy portion 68 of the first driving member 24 arranged on the lower side contract. Therefore, the first shape memory alloy portion 66 is deformed to be convex downward, and the second shape memory alloy portion 68 is deformed to be convex upward. The intermediate connection terminal portion 70 tilts in the counterclockwise direction as viewed from the +Z direction. The tilt of the connecting protrusion 60 is canceled by the first shape memory alloy portions 66 and the second shape memory alloy portions 68, and the mover 14 is moved in the +Z direction with its tilt being suppressed.

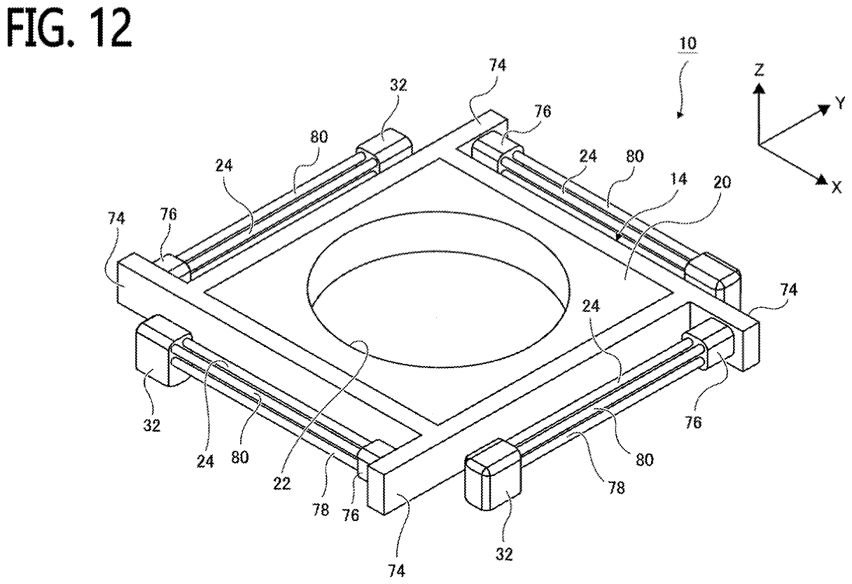

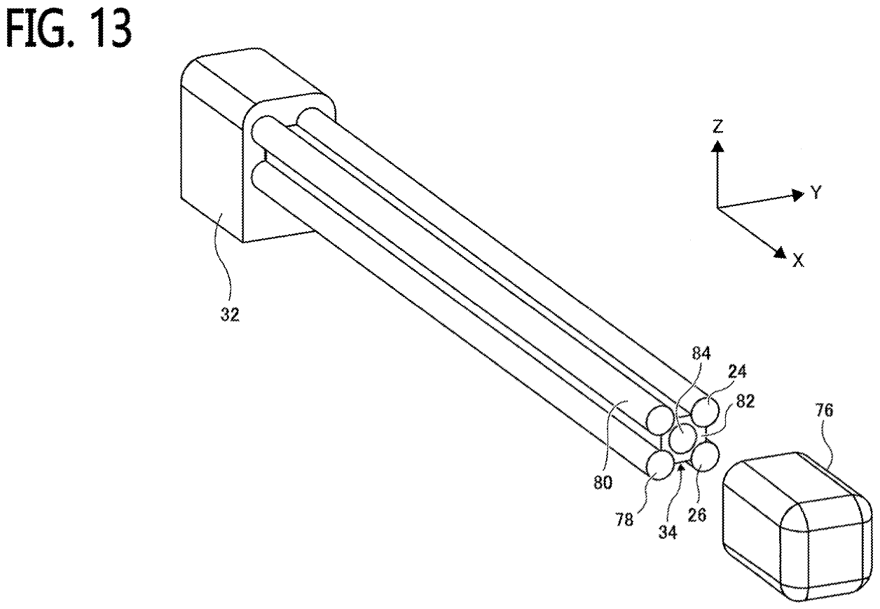

FIG. 12 and FIG. 13 are illustrations of a lens driving device 10 according to a fourth embodiment of the present invention.

In the fourth embodiment, connection terminal fixing portions 74 protrude from four corners of the mover main body portion 20, and mover-side connection terminals 76 are fixed to the respective connection terminal fixing portions 74.

Further, in the fourth embodiment, in addition to the first driving members 24 and the second driving members 26, third driving members 78 and fourth driving members 80 are provided. FIG. 13 is an illustration of a set of the first driving member 24, the second driving member 26, the third driving member 78, and the fourth driving member 80 arranged on the −Y side in FIG. 12. The first driving member 24, the second driving member 26, the third driving member 78, and the fourth driving member 80 are provided to be arranged side by side to form a circulation arrangement at intervals of 90 degrees as rotational symmetry about the direction in which the members extend. That is, in FIG. 13, the third driving member 78 is arranged apart from the second driving member 26 in the −Y direction, and is arranged in parallel to the second driving member 26 in the X direction at the same position in the Z direction. The fourth driving member 80 is arranged apart from the first driving member 24 in the −Y direction, and is arranged in parallel to the first driving member 24 in the X direction at the same position in the Z direction.

Further, the first driving member 24, the second driving member 26, the third driving member 78, and the fourth driving member 80 are arranged to surround the intermediate support member 34. The intermediate support member 34 includes an insulating portion 82 arranged at its periphery, and a conductive portion 84 arranged at its center. The insulating portion 82 integrally fixes the first driving member 24, the second driving member 26, the third driving member 78, the fourth driving member 80, and the conductive portion 84 to each other in a non-contact manner.

In the fourth embodiment, sets each formed of the first driving member 24, the second driving member 26, the third driving member 78, and the fourth driving member 80 are arranged to form four-fold rotational symmetry (90-degree symmetry) around the mover 14.

In the fourth embodiment, for example, when the first driving member 24 and the fourth driving member 80 are energized or when the second driving member 26 and the third driving member 78 are energized, the mover 14 can be moved in the ±Z direction. Further, when the first driving member 24 and the second driving member 26 arranged on the −Y side and the third driving member 78 and the fourth driving member 80 arranged on the +Y side across the mover main body portion 20 are energized, the mover 14 can be moved in the +Y direction. When the driving members arranged on the other sides are energized, the mover 14 can be moved in the −Y direction. Further, when the first driving member 24 and the second driving member 26 arranged on the −X side and the third driving member 78 and the fourth driving member 80 arranged on the +X side across the mover main body portion 20 are energized, the mover 14 can be moved in the +X direction. When the driving members arranged on the other sides are energized, the mover 14 can be moved in the −X direction. In the fourth embodiment, even through use of one set of the first driving member 24, the second driving member 26, the third driving member 78, and the fourth driving member 80, the mover 14 can be moved in the ±Z direction, and the ±Y direction or the ±X direction.

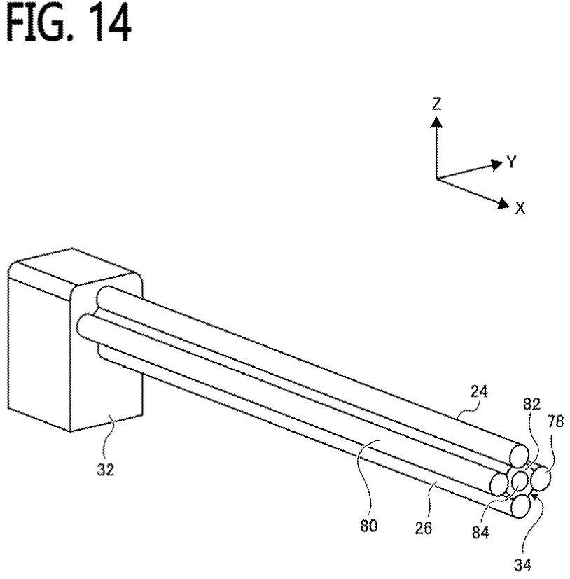

FIG. 14 is an illustration of a fifth embodiment of the present invention.

In the fifth embodiment, positions of the first driving member 24, the second driving member 26, the third driving member 78, and the fourth driving member 80 are shifted by 45 degrees from those in the fourth embodiment, and the second driving member 26 and the third driving member 78 are switched. The first driving member 24, the second driving member 26, the third driving member 78, and the fourth driving member 80 are similarly provided to be arranged side by side to form a circulation arrangement in a random order at intervals of 90 degrees as rotational symmetry about the direction in which the members extend. Further, in the Z direction, the first driving member 24, the conductive portion 84, and the second driving member 26 are arranged side by side in order from the +Z side. Further, in the Y direction, the third driving member 78, the conductive portion 84, and the fourth driving member 80 are arranged side by side in order.

In the fifth embodiment, the mover 14 is moved in the +Z direction when each first driving member 24 is energized, and the mover 14 is moved in the −Z direction when each second driving member 26 is energized. Further, when the third driving member 78 arranged on the −Y side and the fourth driving member 80 arranged on the +Y side across the mover main body portion 20 are energized, the mover 14 cars be moved in the +Y direction. When the driving members arranged on the other sides are energized, the mover 14 can be moved in the −Y direction. Further, when the third driving member 78 arranged on the −X side and the fourth driving member 80 arranged on the +X side across the mover main body portion 20 are energized, the mover 14 can be moved in the +X direction. When the driving members arranged on the other sides are energized, the mover 14 can be moved in the −X direction. As described above, when one predetermined driving member among the driving members arranged at each location is energized, the mover 14 can be moved independently in each of the XYZ directions. In the fifth embodiment, even through use of one set of the first driving member 24, the second driving member 26, the third driving member 78, and the fourth driving member 80, the mover 14 can be moved in the ±Z direction, and the ±Y direction or the ±X direction.

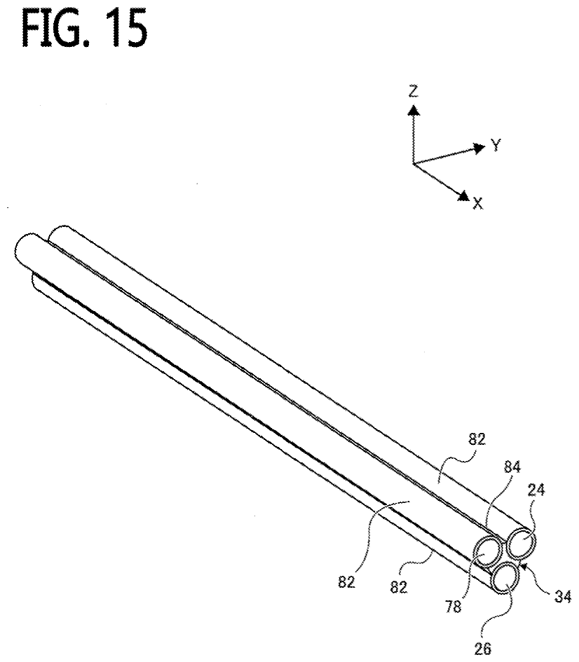

FIG. 15 is an illustration of a sixth embodiment of the present invention.

The sixth embodiment differs from the fourth and fifth embodiments in that only three driving members, specifically, the first driving member 24, the second driving member 26, and the third driving member 78 are provided in the sixth embodiment in contrast to the fourth and fifth embodiments in which four driving members, specifically, the first driving member 24, the second driving member 26, the third driving member 78, and the fourth driving member 80 are provided. The first driving member 24, the second driving member 26, and the third driving member 78 are provided to be arranged side by side to form a circulation arrangement at intervals of 120 degrees as rotational symmetry about the direction in which the members extend. The first driving member 24 and the third driving member 78 are arranged side by side in the Y direction, and the second driving member 26 and a combination of the first driving member 24 and the third driving member 78 are arranged side by side in the Z direction. Further, in the sixth embodiment, the intermediate support member 34 is formed of the conductive portion 84, and the first driving member 24, the second driving member 26, and the third driving member 78 are integrally formed with the insulating portion 82 being provided at the periphery of each member. In FIG. 15, when any one of the second driving member 26 and the combination of the first driving member 24 and the third driving member 78 is energized, the mover 14 can be moved in the Z direction. When any one of the first driving member 24 and the third driving member 78 is energized, the mover 14 can be moved in the Y direction. In the sixth embodiment, similarly to FIG. 12, sets each formed of the first driving member 24, the second driving member 26, and the third driving member 78 may be arranged to form four-fold rotational symmetry (90-degree symmetry) around the mover 14.

In the above-mentioned embodiments, description is given of an example in which the present invention is applied to the lens driving device or the camera device, but the present invention is applicable to an electronic apparatus including the camera device.

What is claimed is:

1. A lens driving device, comprising:
a stator;
a mover, which is supported to be freely movable with respect to the stator, and includes a lens holder configured to hold a lens; and
a first driving member and a second driving member, which are provided apart from each other in a moving direction of the mover, and extend in a direction intersecting with the moving direction of the mover, the first driving member and the second driving member each including a shape memory alloy portion,
wherein, in the first driving member and the second driving member, one end of the first driving member and one end of the second driving member are connected to the stator, and another end of the first driving member and another end of the second driving member are connected to the mover.

2. The lens driving device according to claim 1, further comprising an intermediate support member, which is arranged in the direction intersecting with the moving direction of the mover, and is arranged between the first driving member and the second driving member,
wherein, in the intermediate support member, one end of the intermediate support member is connected to the stator, and another end of the intermediate support member is connected to the mover.

3. The lens driving device according to claim 2,
wherein the intermediate support member is made of a conductive material, and is to be electrically connected selectively to any one of the first driving member and the second driving member.

4. The lens driving device according to claim 1, further comprising an elastic member to connect the first driving member and the second driving member to the mover through the mover and a set of the first driving member and the second driving member,
wherein the elastic member is configured to be deformed so as to allow movement of the mover.

5. The lens driving device according to claim 1, further comprising a guide portion provided between the stator and the mover,
wherein the guide portion is configured to guide the mover to be freely movable with respect to the stator.

6. The lens driving device according to claim 5, wherein the guide portion includes a spherical member arranged between the stator and the mover.

7. The lens driving device according to claim 6, wherein the guide portion includes a regulating member configured to regulate movement of the spherical member in the moving direction of the mover.

8. The lens driving device according to claim 6, wherein the guide portion has a guide groove to which the spherical member is fitted in a direction orthogonal to the moving direction of the mover.

9. The lens driving device according to claim 1, wherein at least one of the first driving member or the second driving member includes a first part extending from the stator to the mover, and a second part returning to the stator from the mover.

10. The lens driving device according to claim 1, wherein a width between the first driving member and the second driving member in the moving direction of the mover is narrowed toward the mover.

11. The lens driving device according to claim 1,
wherein each of the first driving member and the second driving member includes a first shape memory alloy portion connected to the stator, a second shape memory alloy portion connected to the mover, and an intermediate connection terminal portion configured to connect between the first shape memory alloy portion and the second shape memory alloy portion, and
wherein, in the first driving member and the second driving member, positions of the first shape memory alloy portion and the second shape memory alloy portion are switched in the moving direction of the mover with respect to the intermediate connection terminal portion serving as a boundary.

12. The lens driving device according to claim 1, wherein sets of a plurality of first driving members and a plurality of second driving members are arranged in rotational symmetry around the mover.

13. The lens driving device according to claim 1, further comprising a third driving member connected to the stator and the mover,
wherein the third driving member is provided to be arranged side by side with respect to the first driving member and the second driving member, and forms a circulation arrangement together with the first driving member and the second driving member at intervals of 120 degrees as rotational symmetry about a direction in which the first driving member, the second driving member, and the third driving member extend.

14. The lens driving device according to claim 1, further comprising a third driving member and a fourth driving member each connected to the stator and the mover,
wherein the third driving member and the fourth driving member are provided to be arranged side by side with respect to the first driving member and the second driving member, and form a circulation arrangement together with the first driving member and the second driving member at intervals of 90 degrees as rotational symmetry about a direction in which the first driving member, the second driving member, the third driving member, and the fourth driving member extend.

15. The lens driving device according to claim 14, wherein the third driving member and the fourth driving member are provided to be arranged side by side in a direction orthogonal to the moving direction of the mover.

16. The lens driving device according to claim 13, wherein the first driving member, the ascend driving member, and the third driving member are integrally formed.

17. The lens driving device according to claim 14, wherein the first driving member, the second driving member, the third driving member, and the fourth driving member are integrally formed.

18. A camera device, comprising the lens driving device of claim 1.

19. An electronic apparatus, comprising the camera device of claim 18.
